(19) United States
(12) Patent Application Publication
(10) Pub. No.: US 2026/0014434 A1
(43) Pub. Date: Jan. 15, 2026

(54) DURABLE PICKLEBALL RACKET

(71) Applicant: Yu Jen Chang, Taichung (CN)

(72) Inventor: Yu Jen Chang, Taichung (CN)

(21) Appl. No.: 18/767,647

(22) Filed: Jul. 9, 2024

(51) Int. Cl. A63B 59/42; A63B 60/54; A63B 102/08; B32B 3/08; B32B 3/12; B32B 27/06; B32B 27/32

(52) U.S. Cl. CPC A63B 59/42; A63B 60/54; B32B 3/08; B32B 3/12; B32B 27/06; B32B 27/32; A63B 2102/08; A63B 2209/023; B32B 2250/40

(57) ABSTRACT

A durable pickleball racket comprises a racket body and a panel, wherein the panel comprises one or two layers attached to one or two sides of the racket body, the racket body comprises a handle portion and a racket portion, the racket portion is fixedly connected to the handle portion and comprises a frame and a core board inlaid in the frame, the core board is a homogenous core board or a composite core board, and a plurality of struts are inlaid in the core board. The durable pickleball racket provided by the invention not only can effectively improve the anti-hitting performance, prolong the effective hitting time, retard or reduce permanent deformation and prolong the service life, but also can resist deformation caused by powerful hitting and satisfy lightweight and shock-absorption requirements, thus being an improved product comprehensively balancing strength and quality.

### BACKGROUND OF THE INVENTION

### 1. Technical Field

The invention relates to the technical field of ball sports equipment, in particular to the technical field of pickleball rackets and materials for making rackets.

### 2. Description of Related Art

Pickleball is a sport that hits balls with rackets and originated from Bainbridge Island, Seattle in the United States. It is also a competitive sport for one or more players, similar to tennis, and requires less physical strength than tennis and more physical strength than badminton and table tennis. Tennis is easily limited by the field and equipment and cannot be played as conveniently and economically as pickleball. After pickleball from the United State spread into China, it becomes popular because it requires moderate exercise, is less limited by the field and has low requirements for sports equipment, and it is not only a favorite of teenagers and adults, but also is popularized more widely among the elderly. Nowadays, more and more people start to pay attention to their physical health and do exercise frequently, and pickleball becomes a sport with overwhelming superiority in exercise amount, field and racket cost.

Common pickleball rackets on the market adopt polypropylene (PP) honeycomb boards which are made from PP. For example, Patent Application No. CN202210871913.5, entitled Pickleball Racket and Manufacturing Method Thereof, discloses a racket structure, wherein a racket body comprises an upper panel, a lower panel and a honeycomb board sandwiched between the upper panel and the lower panel. Such a racket structure changes the weight of the racket panel, improves the shock-absorption effect and reduces the overall weight. However, it is found in actual use that the racket panel will be dented after being used for hitting balls for a long time, and unrecoverable permanent deformation of the racket panel will be caused, thus compromising the service life of the racket. So, it is necessary to improve the racket structure to fulfill a better use effect under the precondition of guaranteeing the shock-absorption effect, the lightweight requirement and the anti-hitting performance.

### BRIEF SUMMARY OF THE INVENTION

In view of the above problems, the invention provides a durable pickleball racket which can effectively improve the anti-hitting performance, prolong the effective hitting time, retard or reduce permanent deformation and prolong the service life. The pickleball racket not only can resist deformation caused by powerful hitting, but also can satisfy lightweight and shock-absorption requirements, thus being an improved product comprehensively balancing strength and quality.

The invention relates to a durable pickleball racket, comprising a racket body and a panel, the panel comprising one or two layers attached to one or two sides of the racket body, wherein the racket body comprises a handle portion and a racket portion, and the racket portion is fixedly connected to the handle portion and comprises a frame and a core board inlaid in the frame.

The core board is a homogenous core board or a composite core board.

In a case where the core board is a homogenous core board, the homogenous core board is a honeycomb board integrally formed by a polypropylene material.

In a case where the core board is a composite core board, the composite core board is a composite board formed by bonding at least three layers of materials, wherein the two outermost layers are polypropylene honeycomb boards, the layer sandwiched between the two outermost layers is a bearing board, and the bearing board is integrally formed by a corkwood material, a foam material or an ethylene-vinyl acetate copolymer material.

Further, no matter whether the homogenous core board or the composite core board is adopted, to further improve the strength of the pickleball racket and prolong the service life of the pickleball racket, a plurality of struts are inlaid in the core board, and the struts vertically penetrate through the core board.

Four struts are respectively arranged at four corners of the core board.

More than four said struts are uniformly distributed in a middle position of the core board in an array.

The struts are cuboid or cylindrical and each comprise a main part made from a foam material or an ethylene-vinyl acetate copolymer material and a carbon fiber film wrapping the main part.

The durable pickleball racket provided by the invention not only can effectively improve the anti-hitting performance, prolong the effective hitting time, retard or reduce permanent deformation and prolong the service life, but also can resist deformation caused by powerful hitting and satisfy lightweight and shock-absorption requirements, thus being an improved product comprehensively balancing strength and quality.

### BRIEF DESCRIPTION OF THE SEVERAL VIEWS OF THE DRAWINGS

FIG. 1 is a schematic structural diagram of a durable pickleball racket according to Embodiment 1 of the invention;

FIG. 2 is a schematic diagram of a durable pickleball racket according to Embodiment 2 of the invention;

FIG. 3 is a schematic distribution diagram of struts of a durable pickleball racket according to Embodiment 3 the invention;

wherein, 10, racket body; 11, handle portion; 12, racket portion; 121, frame; 20, panel; 21, first panel; 22, second panel; 30, core board; 31, honeycomb board; 32, bearing board; 40, strut.

### DETAILED DESCRIPTION OF THE INVENTION

The invention will be described in detail below in conjunction with the accompanying drawings and embodiments, and examples of the embodiments are shown in the accompanying drawings, in which identical or similar reference signs indicate identical or similar elements or elements with identical or similar functions. The embodiments described below with reference to the accompanying drawings are illustrative and only used for explaining the invention, and should not be construed as limitations of the invention.

In the description of the invention, it should be understood that terms such as “central”, “upper”, “lower”, “front”, “back”, “left”, “right”, “vertical”, “horizontal”, “top”, “bottom”, “inner” and “outer” are used to indicate directional or positional relations based on the accompanying drawings merely for the purpose of simplifying and facilitating the description of the invention, do not indicate that devices or elements referred to must be in a specific direction or being configured and operated in a specific direction, and thus should not be construed as limitations of the invention.

### Embodiment 1

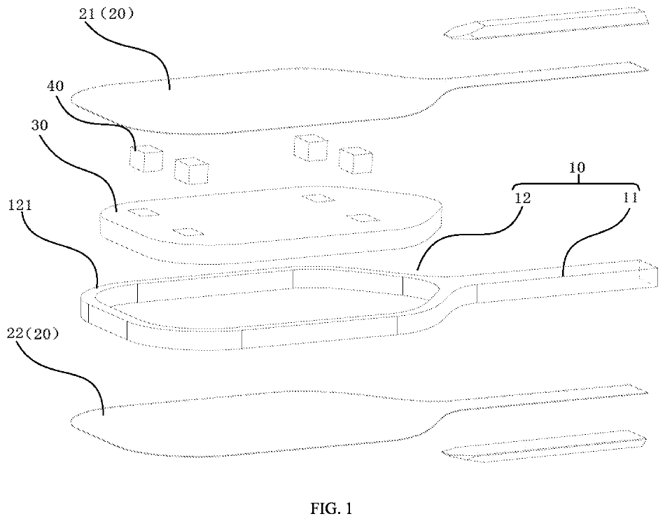

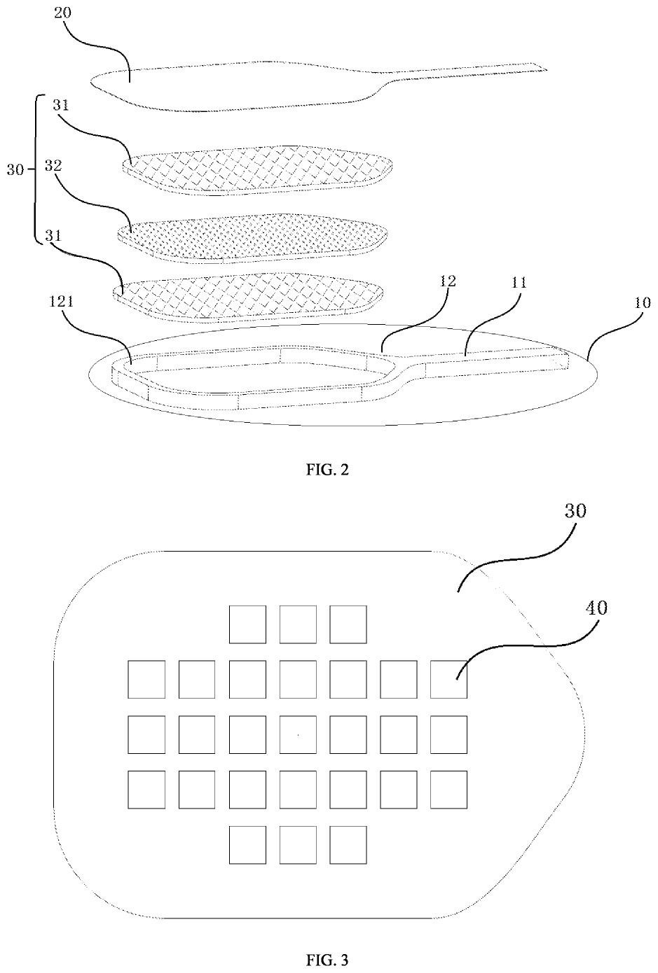

Referring to FIG. 1 which illustrates the structure of a durable pickleball racket in Embodiment 1, the durable pickleball racket comprises a racket body 10 and a panel 20, wherein the panel 20 comprises two layers, which are a first panel 21 and a second panel 22 attached to two sides of the racket body 10 respectively.

The racket body 10 comprises a handle portion 11 and a racket portion 12, wherein the racket portion 12 is fixedly connected to the handle portion 11 and comprises a frame 121 and a core board 20 inlaid in the frame 121, and four struts 40 are inlaid in the core board 30.

It can be clearly seen from FIG. 1 that the struts 40 vertically penetrate through the core board 30. Each strut comprises a main part made from a foam material or an ethylene-vinyl acetate copolymer material and a carbon fiber film wrapping the main part, carbon fibers are coated with resin, and after being attached together with a pre-coated adhesive, the main part and the carbon fiber film are placed in a mold to be cured to form a whole.

The four struts are arranged at four corners of the core board respectively.

In this embodiment, the core board 30 is made from a homogenous material and is a honeycomb board integrally formed by a polypropylene material.

The struts 40 are cuboid or cylindrical and each comprise a main part made from a foam material or an ethylene-vinyl acetate copolymer material and a carbon fiber film wrapping the main part. In this embodiment, the struts 40 are cuboid in structure.

### Embodiment 2

This embodiment is approximately identical in specific structural features with Embodiment 1 and is different from Embodiment 1 in the following structural feature: the core board 40 is a composite core board comprising three layers of materials which are combined into a whole by bonding, the composite material is cut into a core board matching the frame in size and shape, and then the core board is inlaid in the frame 121 of the racket portion 12.

The core board is a composite board formed by bonding three layers of materials, wherein the two outermost layers are polypropylene honeycomb boards 31, the layer sandwiched between the two outermost layers is a bearing board 32, and the bearing board 32 is integrally formed by a corkwood material, a foam material or an ethylene-vinyl acetate copolymer material.

In this embodiment, the composite core board is adopted based on the struts 40, the composite core board improves the durability of the pickleball racket and prolongs the service life of the pickleball racket, and the struts 40 improve the bearing capacity and effect of the pickleball racket.

### Embodiment 3

This embodiment is approximately identical in specific structural features with Embodiment 1 and Embodiment 2 and is different from Embodiment 1 and Embodiment 2 in the following structural feature: more than four struts 40 are arranged, and as shown below, dozens of struts are arranged and uniformly distributed in the middle position of the core board 30 in a common arrangement manner or in an array. The structural feature that multiple struts 40 are distributed in the core board 30 in this embodiment is also applicable to the structure in Embodiment 1 and the structure in Embodiment 2.

The structures and detailed features of the durable pickleball racket are explained and described in detail in conjunction with the above three different embodiments of the invention, and the beneficial effects and improvements in features of the pickleball racket brought by structural improvements are defined: the durable pickleball racket not only can effectively improve the anti-hitting performance, prolong the effective hitting time, retard or reduce permanent deformation and prolong the service life, but also can resist deformation caused by powerful hitting and satisfy lightweight and shock-absorption requirements, thus being an improved product comprehensively balancing strength and quality.

The above embodiments are only preferred ones of the invention and are not intended to limit the invention in any form. Although the invention has been disclosed above with reference to the preferred embodiments, the invention is not limited to the above embodiments. Anyone skilled in the art can make some modifications or embellishments according to the technical contents disclosed above without departing from the scope of the technical solution of the invention to obtain equivalent embodiments, and any simple amendments, equivalent modifications and embellishments made to the above embodiments according to the technique of the invention without departing from the contents of the technical solution of the invention should also fall within the scope of the technical solution of the invention.

What is claimed is:

1. A durable pickleball racket, comprising a racket body and a panel, the panel comprising one or two layers attached to one or two sides of the racket body, wherein the racket body comprises a handle portion and a racket portion, and the racket portion is fixedly connected to the handle portion and comprises a frame and a core board inlaid in the frame.

2. The durable pickleball racket according to claim 1, wherein the core board is a homogenous core board or a composite core board.

3. The durable pickleball racket according to claim 2, wherein the homogenous core board is a honeycomb board integrally formed by a polypropylene material.

4. The durable pickleball racket according to claim 2, wherein the composite core board is a composite board formed by bonding at least three layers of materials, wherein the two outermost layers are polypropylene honeycomb boards, the layer sandwiched between the two outermost layers is a bearing board, and the bearing board is integrally formed by a corkwood material, a foam material or an ethylene-vinyl acetate copolymer material.

5. The durable pickleball racket according to claim 2, wherein a plurality of struts are inlaid in the core board, and the struts vertically penetrate through the core board.

6. The durable pickleball racket according to claim 4, wherein a plurality of struts are inlaid in the composite core board, and the struts vertically penetrate through the composite core board.

7. The durable pickleball racket according to claim 6, wherein four said struts are respectively arranged at four corners of the core board.

8. The durable pickleball racket according to claim 6, wherein more than four said struts are uniformly distributed in a middle position of the core board in an array.

9. The durable pickleball racket according to claim 7, wherein the struts are cuboid or cylindrical and each comprise a main part made from a foam material or an ethylene-vinyl acetate copolymer material and a carbon fiber film wrapping the main part.

10. The durable pickleball racket according to claim 8, wherein the struts are cuboid or cylindrical and each comprise a main part made from a foam material or an ethylene-vinyl acetate copolymer material and a carbon fiber film wrapping the main part.
